(19) United States
(12) Patent Application Publication
(10) Pub. No.: US 2011/0174382 A1
(43) Pub. Date: Jul. 21, 2011

(54) Secondary Containment System Comprising A Mattress And Method Of Using Same

(76) Inventor: Johnathan Paul Merwin, Mesa, AZ (US)

(21) Appl. No.: 13/018,267

(22) Filed: Jan. 31, 2011

Related U.S. Application Data
(60) Provisional application No. 61/360,417, filed on Jun. 30, 2010.

(51) Int. Cl. F15D 1/00; B65D 85/00; B23P 19/00

(52) U.S. Cl. 137/1; 220/562; 29/428

(57) ABSTRACT

A secondary fuel containment system comprising a housing impervious to vehicular fluids and formed to include an opening and a material porous to vehicular fluid disposed within the opening. The housing is sized to accommodate a mattress.

### RELATED APPLICATIONS

This application is a Utility Application claiming priority from a U.S. Provisional Application having Ser. No. 61/360,417 filed Jun. 10, 2010, all of which are incorporated by reference herein.

### BACKGROUND

Many large trucks, including many commercial trucks, have fuel tanks located outside the frame of the vehicle. As a result of this exposure, such fuel tanks are susceptible to damage by roadway hazards. A collision may result in a ruptured fuel tank. In addition, rocks or other debris from nearby vehicles can act as projectiles, puncturing the fuel tanks. Exposed fuel tanks also have greater exposure to the elements. Joints and seams are weakened over time by corrosion, often resulting in leakage. Corrosion can also weaken the overall structural integrity of the tank, providing less protection from the stresses and strains encountered while the vehicle is in operation and against physical impact. Roadway fuel spills are hazardous to both drivers and motorists and often result in serious environmental damage.

In addition to fuels spills, large trucks also frequently leak other liquids, such as oil and transmission fluid. While not as combustible as fuel, these liquids can also create a hazardous condition for motorists and are often as damaging to the environment as fuel.

Vehicles with fuel tanks enclosed within the frame of the vehicle, such as cars, vans, small trucks, and recreational vehicles (RVs) are also susceptible to various fluid leaks, leading to a hazardous condition.

The greatest likelihood of a rupture or leak of a vehicular fuel tank occurs in transit, between a starting location and a destination. Therefore, some sort of emergency containment system would be helpful. Accordingly, it would be an advance in the art to provide a containment system that can effectively capture leaking fluids, can be easily stored within a vehicle, takes up little or no additional room in the vehicle, and is likely to be included on every trip.

### FIELD

The Applicant's invention relates to a secondary containment system and more particularly to a mattress that may be used as a secondary containment system to contain a liquid, including fuel, oil, and transmission fluid, in the event of a leak in the primary containment system (i.e., the fuel tank, engine, or transmission)

### SUMMARY

A secondary fuel containment system is presented. The secondary fuel containment system comprises a housing impervious to vehicular fluids and formed to include an opening. A material porous to vehicular fluid is disposed within the opening.

A method for capturing released vehicular fluids is presented. The method provides a combination vehicle mattress and secondary fuel containment system, comprising a housing formed to include an opening. The housing is impervious to vehicular fluids. A mattress is disposed within the housing. A porous surface is disposed within the opening. The porous surface is porous to vehicular fluids. The method disposes the combination vehicle mattress and secondary fuel containment system such that the released vehicular fluids are directed through the porous surface and into the mattress.

A method for making a combination vehicle mattress and secondary fuel containment system comprising creating a housing impervious to vehicular fluids. An opening is formed in the housing, and the housing is sized to accommodate a mattress. A mattress is disposed within the housing.

### BRIEF DESCRIPTION OF THE DRAWINGS

FIG. 1A is a perspective view of a first embodiment of Applicant's secondary containment system;

FIG. 1B is a cross-sectional view of the embodiment of FIG. 1A;

FIG. 1C illustrates a second drain embodiment;

FIG. 1D shows a cross-sectional view of a metal spring embodiment;

FIG. 2 illustrates a second embodiment of Applicant's secondary containment system where the containment lining is a stand-alone item that can be installed on a conventional mattress;

FIG. 3 illustrates a first method for manufacturing the secondary containment system of FIG. 1;

FIG. 4A illustrates a first step in a second method for manufacturing the secondary containment system of FIG. 1;

FIG. 4B illustrates a second step in the method of FIG. 4A;

FIG. 4C illustrates a third step in the method of FIG. 4A;

FIG. 4D illustrates a subassembly comprising a 5-sided partial housing;

FIG. 4E shows the subassembly of FIG. 4D inverted to form a partial housing for Applicant's secondary containment system;

FIG. 5 is a flowchart summarizing the steps of one embodiment of Applicant's method for using Applicant's secondary containment system;

FIG. 6 is a flowchart summarizing the steps of Applicant's method for making an embodiment of Applicant's secondary containment system;

FIGS. 7A and 7B illustrate another embodiment of Applicant's secondary containment system where the containment lining is a stand-alone item that can be installed on a conventional mattress;

FIG. 8 is a flowchart summarizing the steps of another embodiment of Applicant's method for using Applicant's secondary containment system;

FIG. 9A illustrates one expandable embodiment of Applicant's secondary containment system;

FIGS. 9B and 9C are cross sections that illustrate the use of the expandable embodiment of Applicant's secondary containment system in FIG. 9A for capturing fluid;

FIG. 10 illustrates an expandable embodiment of Applicant's secondary containment system where the containment lining is a stand-alone item that can be installed on a conventional mattress; and

FIG. 11 is a flowchart summarizing the steps of one embodiment of Applicant's method for using Applicant's secondary containment system to capture fuel from a vehicle fuel leak.

### DETAILED DESCRIPTION

This invention is described in preferred embodiments in the following description with reference to the FIGs., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

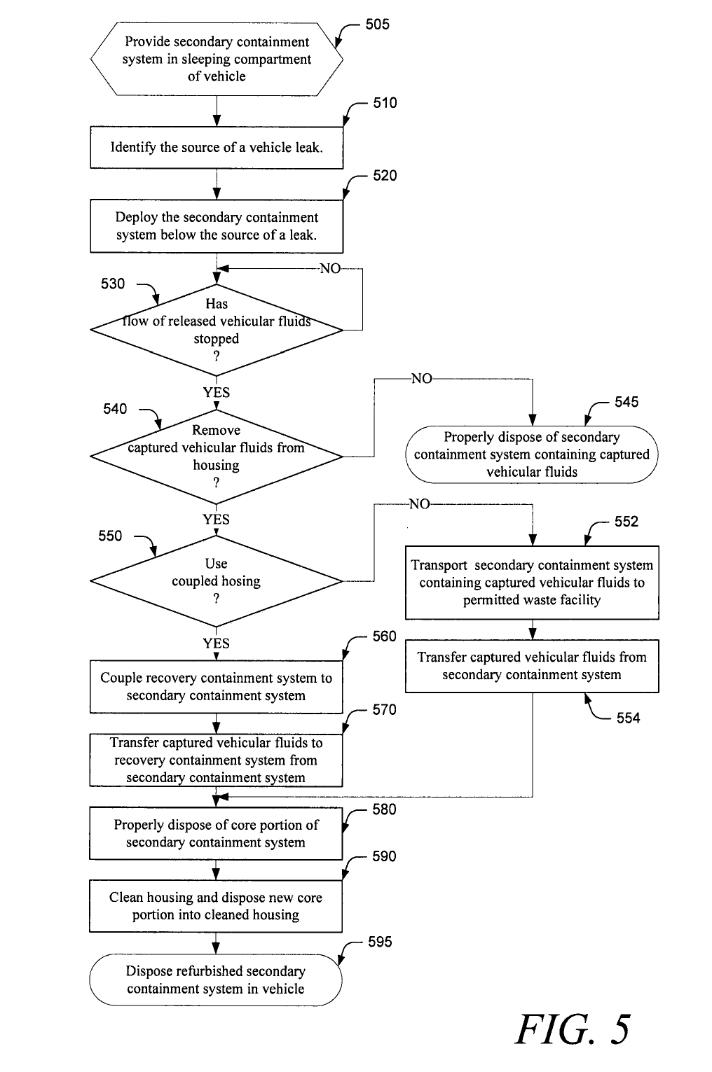

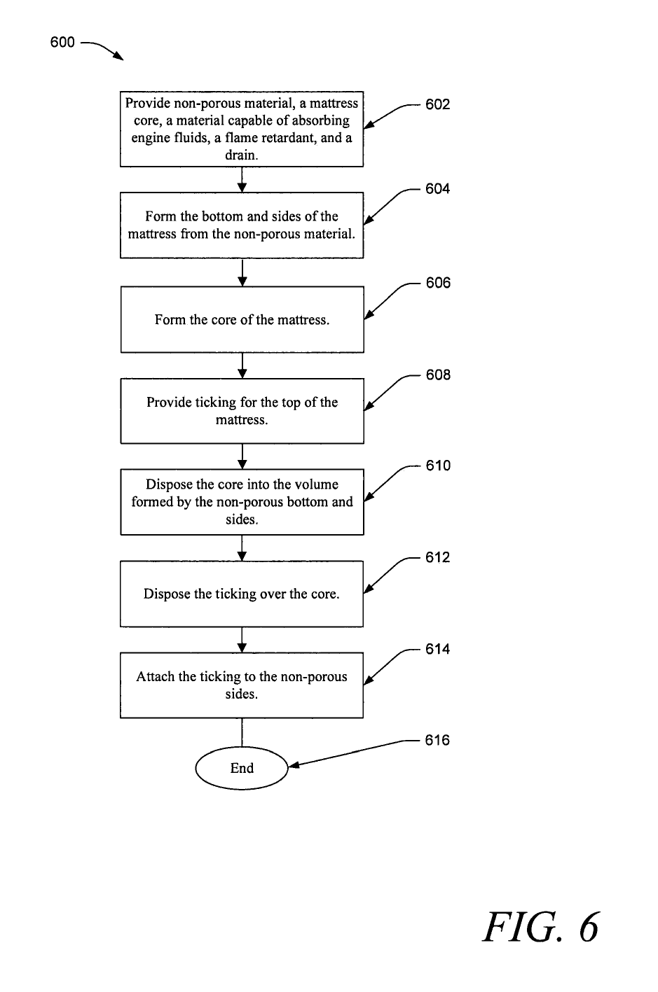

The schematic flow chart diagrams included are generally set forth as logical flow-chart diagrams (e.g., FIGS. 5, 6, 8, and 11). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIGS. 5 and 6). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

In one embodiment, Applicant's invention is configured to replace the beds (or seat cushions) of roadway vehicles. An in-vehicle bed is an important item for many drivers, especially drivers whose vehicles include a sleeper cab. Stand-alone containment and spill remediation systems may be inadvertently forgotten or left behind on a given trip. It is very uncommon, however, for a driver to depart without a mattress on board. Therefore, integrating a secondary containment system into a mattress significantly increases the likelihood that such a secondary containment system will be available in the event of an in-transit leak or spill.

Reference is made herein to various fluids utilized in cars, trucks, and other motorized vehicles. As those skilled in the art will appreciate, gasoline comprises a first set of petroleum distillates, mainly aliphatic hydrocarbons having a defined boiling point range. Diesel fuel comprises a second set of petroleum distillates, including aliphatic hydrocarbons and aromatic/polyaromatic compounds having a higher boiling point range. Brake fluids comprise hydraulic fluids comprising a plurality of glycol ethers. Lubricants, such as without limitation engine oil, comprise a plurality of hydrocarbon compounds. For purposes of this application, gasoline, diesel fuel, lubricants, and/or brake fluids, are referred to collectively as “vehicular fluids.”

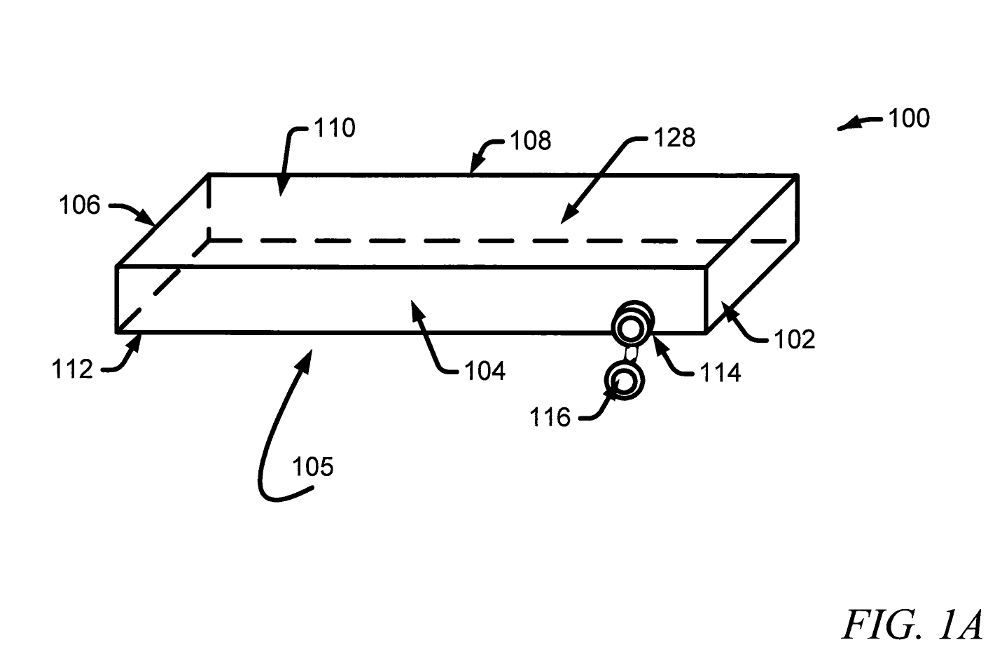

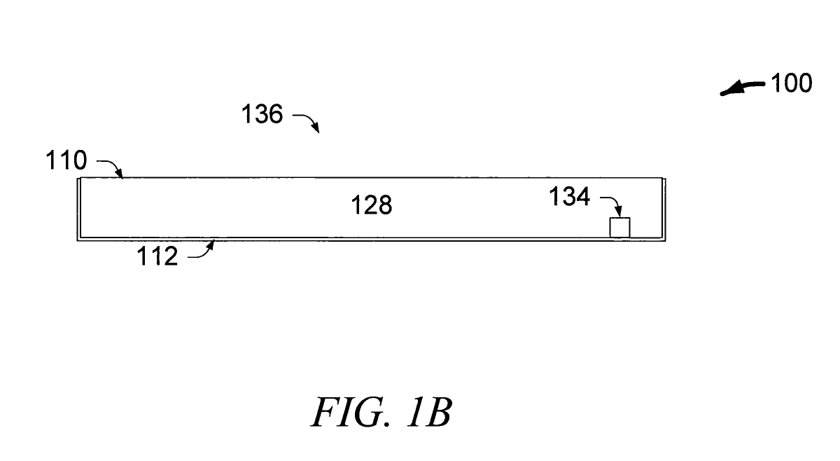

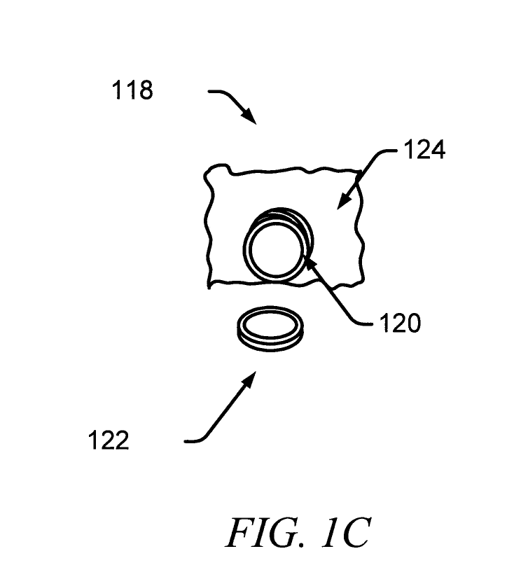

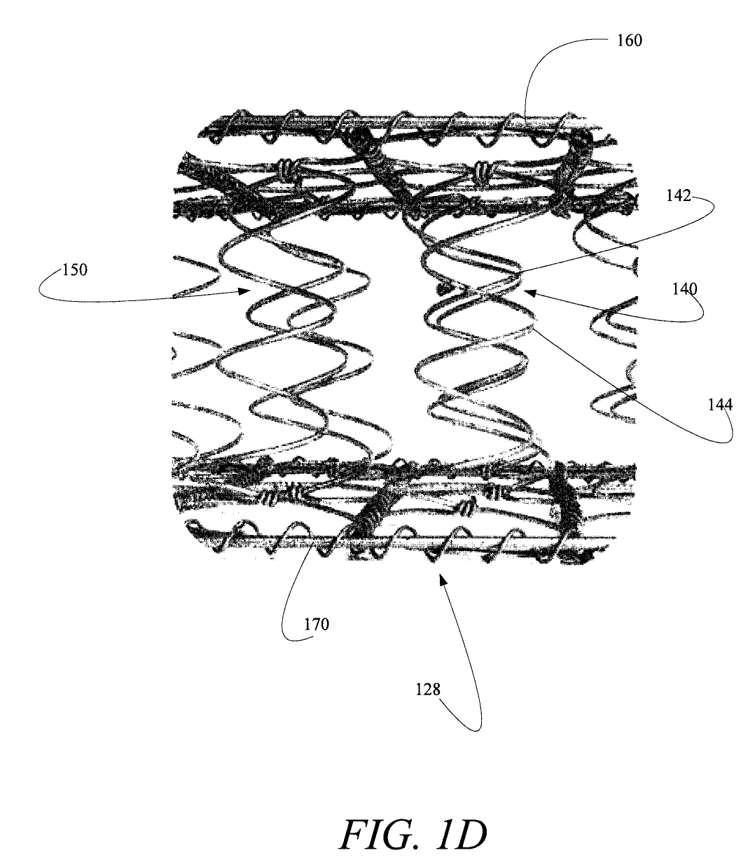

FIG. 1A illustrates one embodiment of Applicant's secondary containment system 100. The secondary containment system 100 includes a core 128 and a housing 105. In one embodiment, the housing 105 is roughly approximated by a parallelepiped. A parallelepiped is a three dimensional object formed by six parallelograms. For purposes of clarity and when used herein, the term parallelepiped may signify, in addition to its strict definition, both (i) a figure with a parallelogram for each of the six sides and (ii) a figure with a quadrilateral for one or more of the six sides. In addition, the edges of the parallelepiped, where the sides intersect, may not be abrupt, but instead may be rounded so that the sides merge into each other gradually. Accordingly, as used herein, the term parallelepiped may also signify a shape that largely represents a parallelepiped in the strict sense, but with the deviations that result when constructed with non-rigid material.

In certain embodiments, core 128 comprises a plurality of springs formed of wire and disposed between an upper and a lower metal mesh structure. In another embodiment, the core comprises a cellular material, i.e., a foam. In one embodiment, core 128 comprises polyurethane foam having about 1.2-1.5 lbs per square inch. In yet another embodiment, the core further comprises one or more materials capable of absorbing and retaining vehicular fluids. In another embodiment, the material capable of absorbing vehicular fluids may also be hydrophobic, allowing it to absorb and retain vehicular fluids without absorbing water, thereby maximizing the amount of vehicular fluids that can be captured. In yet another embodiment, the core includes baffles to compartmentalize the captured vehicular fluids. In yet another embodiment, the core includes, or is capable of receiving, one or more chemical compounds that renders petroleum-based fuels non-flammable, such as PETRO-CLEAN. In yet another embodiment, the core includes one or more flame retardant materials that become dissolved in or dispersed in vehicular fluids when those vehicular fluids are directed onto, and into, Applicant's secondary containment system. In yet another embodiment, the core includes, or is capable of receiving, one or more chemical compounds capable of reacting with petroleum-based fuels to create a gel.

FIG. 1D illustrates an embodiment utilizing a core 128 comprising a metal spring mattress. In the illustrated embodiment of FIG. 1D, core 128 comprises a plurality of metal spring assemblies, such as assemblies 140 and 150, disposed between a top metal mesh structure 160 and a bottom metal mesh structure 170. In the illustrated embodiment of FIG. 1D, metal spring assembly 140 comprises individual metal spring 142. In certain embodiments, spring 142 comprises a coating 144, wherein coating 144 is soluble in gasoline, diesel fuel, and or hydraulic fluid.

As an example and without limitation, in certain embodiments, coating 144 comprises polystyrene. If gasoline or diesel fuel is disposed within housing 105, the polystyrene coating 144 becomes dissolved in the captured gasoline/diesel fuel. The dissolved polystyrene polymer chains cause the captured gasoline/diesel fuel to gel, thereby facilitating interim storage of such leaking fuels.

Referring back to FIG. 1A, housing 105 comprises side portions 102, 104, 106, and 108, in combination with top 110 and bottom 112. The side portions 102, 104, 106, 108 and bottom portion 112 are constructed from a non-porous material that is impervious to vehicular fluids. Any material that is impervious to vehicular fluids may be used. The side portions 102, 104, 106, and 108 and the bottom portion 112 create a barrier capable of retaining, within the housing 105, any vehicular fluids that pass through the top portion 110.

In one embodiment, the non-porous material is plasticized polyvinyl chloride fabric (“vinyl”). In certain embodiments, the non-porous material is 10 ounce weight vinyl (i.e., vinyl weighing 10 ounces per square yard).

In certain embodiments, side portions 102, 104, 106, 108, and bottom portion 112, are formed from high density polyethylene (“HDPE”). As those skilled in the art will appreciate, many fuel tanks are formed by molding HDPE. In certain embodiments, side portions 102, 104, 106, 108, and bottom portion 112, comprise an integrally molded, HDPE shell. In these embodiments, core 128 is disposed within such a HDPE shell, and then top portion 110 is releaseably attached to the HDPE shell. After use of the secondary containment system to capture leaking vehicular fluids, the captured fluids can be removed from the HDPE shell structure, the core 128 can be discarded, and the HDPE shell can be cleaned and re-used with a new core 128.

In certain embodiments, side portions 102, 104, 106, 108, and bottom 112, are formed from a flexible polyethylene foam fabric. In certain embodiments, side portions 102, 104, 106, 108, and bottom 112, are formed from a 0.25 inch thick, 2.5 pound per cubic foot, polyethylene foam material. In certain embodiments, side portions 102, 104, 106, 108, and bottom 112, are formed from a 0.25 inch thick, 4.5 pound per cubic foot, polyethylene foam material. In certain embodiments, side portions 102, 104, 106, 108, and bottom 112, are formed from a 0.50 inch thick, 3.3 pound per cubic foot, polyethylene foam material.

In these flexible polyethylene foam embodiments, after use of the secondary containment system to capture leaking vehicular fluids, the captured fluids can be removed from the polyethylene foam shell structure, the core 128 can be discarded, and the polyethylene foam shell structure can be cleaned and re-used with a new core 128.

In embodiments, wherein side portions 102, 104, 106, 108, and bottom 112, are formed from vinyl, polyethylene foam, or another flexible fabric, seams connecting the side portions 102, 104, 106, and 108 and the bottom portion 112 are formed to also be non-porous and impervious to vehicular fluids. In one embodiment, the seams are formed by an ultrasonic seaming device, which uses acoustics to fuse material at the molecular level. In another embodiment, the seams are formed with an impulse sealer, which uses heat to melt and fuse the material together. In yet another embodiment, the seams are formed with an adhesive, such as an epoxy compound, to fuse the material together.

In certain embodiments, core 128 is disposed within a portion of housing 105, and then top portion 110 is disposed over the core and attached to the side portions 102, 104, 106, and 108, which along with the bottom portion 112, encase the core. Any closure means can be used for attachment. In one embodiment, the top portion 110 is fastened to the side portions 102, 104, 106, and 108 by stitching with thread. In one embodiment, the top portion 110 is removeably attached to the side portions 102, 104, 106, and 108 by a zipper.

The top portion 110 is constructed to allow vehicular fluids that come in contact with the surface of the top portion 110 to pass through and into the core 128. In certain embodiments, top portion 110 comprises a mattress ticking material configured to be porous to vehicular fluids. In one embodiment, the top portion 110 comprises cotton, silk, wool, and combinations thereof.

In one embodiment, secondary containment system 100 is formed to include a drain 114 (i.e., aperture) on side portion 104. In other embodiments, the drain 114 is disposed on any one or more of side portions 102, 104, 106, 108, the top portion 110, or the bottom portion 112. A drain cap 116 is used to selectively open or close the drain 114. The drain provides a means for removing captured vehicular fluids. In one embodiment, removal of captured vehicular fluids includes extraction by applying suction to drain 114.

Referring now to FIG. 1C, in other embodiments, a threaded drain 120 is attached to the secondary containment system surface 124. In different embodiments, the secondary containment system surface 124 may comprise one or more of top portion 110, side portions 102, 104, 106, 108, or the bottom portion 112. The threaded drain 120 permits releasable attachment of a threaded coupling and hose to drain 120. A threaded drain cap 122 is placed on the threaded drain 120 and screwed in place to create a seal that is impervious to liquids. In one embodiment, after the secondary containment system has captured leaked vehicular fluids, the threaded drain cap 122 may be released to permit the vehicular fluids to flow out. In another embodiment, after removal of the threaded drain cap 122, a drain hose is securely attached to the threaded drain 120 to guide the flow of vehicular fluids into a desired location. In yet another embodiment, after removal of the threaded drain cap 122, a vacuum hose is securely attached to the threaded drain 120 to draw the vehicular fluids out of the secondary containment system 100 under suction.

FIG. 1B shows a cross section 136 of secondary containment system 100. The top portion 110 covers the top of the core 128. In one embodiment, the core 128 comprises polyurethane foam. In the illustrated embodiment of FIG. 1B, a porous tubular member 134 is disposed on the inner surface of bottom 112, and extends along the width of the secondary containment system 100.

In certain embodiments, porous tubular member 134 communicates with the drain 114 or 120. Porous tubular member 134 allows captured vehicular fluids to flow outwardly from drain 114 of 120. In different embodiments, porous tubular member 134 comprises a rectangular-shaped or tubular-shaped channel formed in core 128.

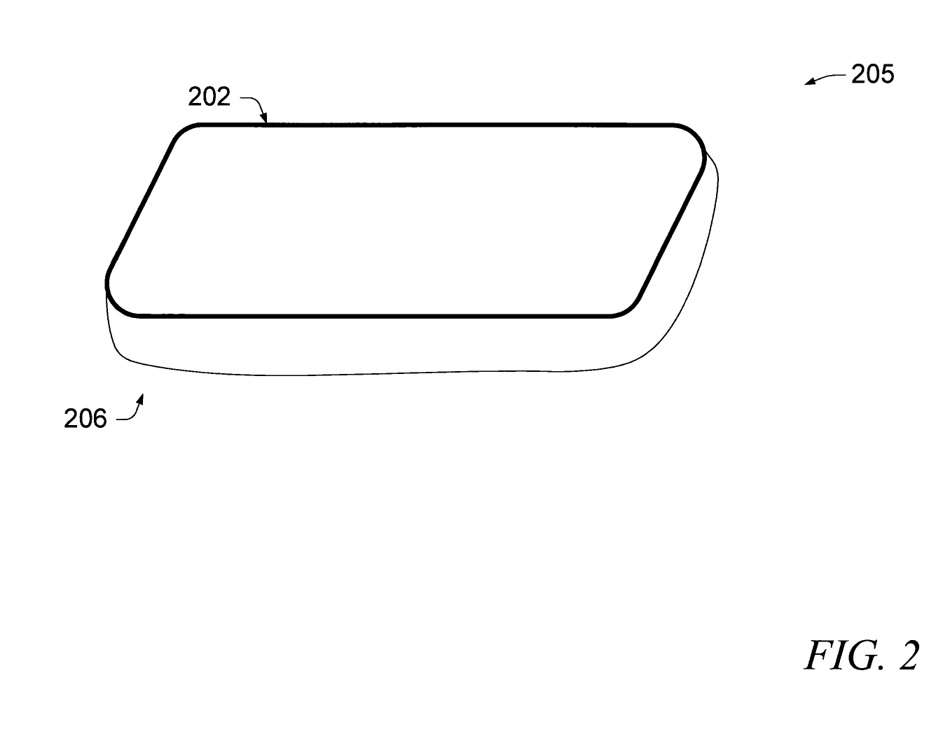

FIG. 2 illustrates a flexible and integral partial housing 205. The partial housing 205 can be disposed over the bottom and sides of a conventional mattress. The partial housing 205 provides a barrier capable of retaining any vehicular fluids that pass through the top of the mattress.

In one embodiment, an elastic strip 202 is attached to a peripheral edge of the body 206. The elastic strip 202 and body 206 are sized to fit a given mattress. When the body is disposed around the bottom and sides of the mattress, elastic strip 202 is disposed on the mattress top such that body 206 extends down the sides and over the bottom of the mattress. When fitted and in place, the elastic strip 202 is stretched, thereby exerting an inward force pulling the liner body 206 securely over the sides and bottom of the mattress.

In one embodiment, a strap 202, constructed in different embodiments of nylon, fabric, metal, or plastic, is attached to a peripheral edge of the body 206. When the body is disposed around the bottom and sides of the mattress, strap 202 is disposed on the mattress top such that body 206 extends down the sides and over the bottom of the mattress. When fitted and in place, the strap 202 is tightened, thereby contracting the opening formed by the peripheral edge of the body 206. This creates an inward force pulling the body 206 securely over the sides and bottom of the mattress.

The body 206 is constructed from a non-porous material that is impervious to vehicular fluids. In one embodiment, the non-porous material is vinyl. In another embodiment, the non-porous material is 10 ounce weight vinyl (i.e., vinyl weighing 10 ounces per square yard). In certain embodiments, body 206 is constructed from flexible polyethylene foam.

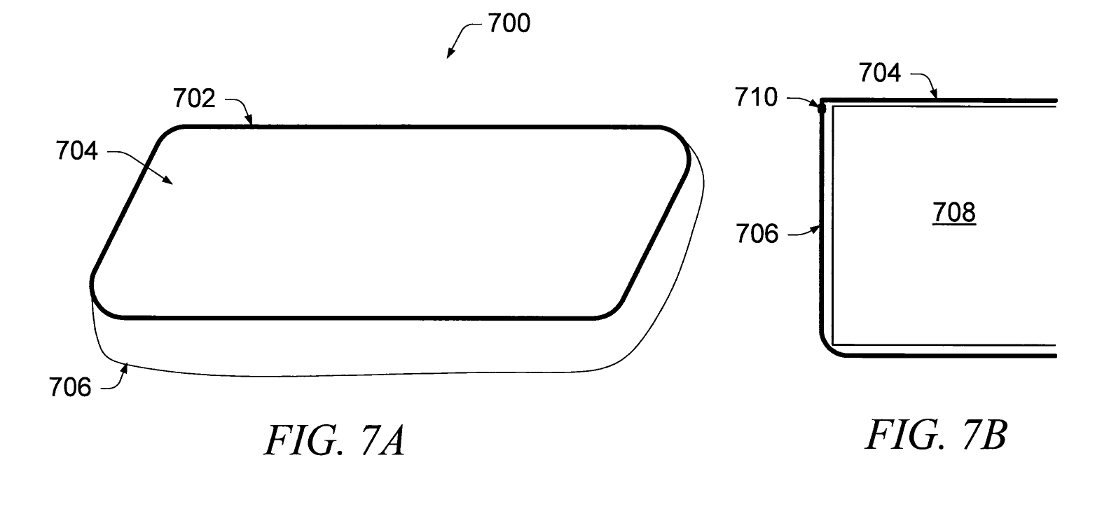

FIG. 7A illustrates one embodiment of a flexible housing 700. In one embodiment, a conventional mattress is disposed into the housing 700. The housing 700 comprises a top potion 704 that covers the top portion of the mattress. The top portion 704 is configured to be porous to vehicular fluids. The housing 700 comprises a body 706 which covers the four sides and the bottom of the mattress. The body 706 provides a barrier capable of retaining any vehicular fluids that pass through the top portion 704 and into the mattress. In one embodiment, the body is sized to fit a mattress of a particular size. In one embodiment, the body is sized to fit mattresses of different sizes.

In one embodiment, the top portion 704 is releasably attached to the body 706 by releasable attachment means 702 disposed along the periphery of top 704. The releasable attachment enables the housing 700 to be disposed over a conventional mattress and removed when necessary. This embodiment allows the housing (in combination with the mattress) to function as a secondary containment system when necessary. This embodiment also allows the housing to protect the mattress when the mattress is used as a bed. The housing may be periodically replaced as necessary when, for example, the housing gets dirty, drivers switch trucks, or the housed mattress is replaced.

Referring to FIG. 7B, a cross section of a portion of an embodiment of the flexible housing 700 with a releasably attached top portion is depicted. A mattress core 708 is enclosed by a top portion 704 and a body portion 706. The top portion is releasably attached to the body portion 706 by a releasable attachment means 710. In different embodiments, the releasable attachment means 710 comprises a metal or plastic zipper or a hook and loop fastener. In one disposable embodiment, the attachment means comprises a permanent seam with a rip cord.

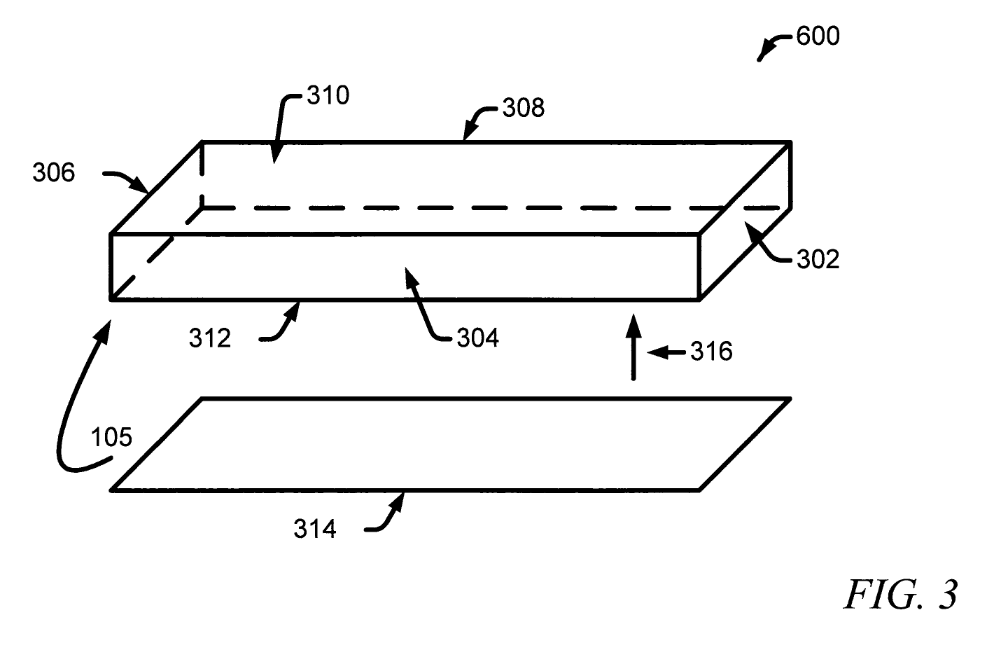

FIG. 3 graphically summarizes one method to manufacture housing 105. The side portions 302, 304, 306, and 308 and the bottom portion 314, are individually formed from one or more non-porous materials impervious to vehicular fluids. Any flexible material that is impervious to vehicular fluids may be used. In one embodiment, the non-porous material is vinyl. In another embodiment, the non-porous material is 10 ounce weight vinyl (i.e., vinyl weighing 10 ounces per square yard). In certain embodiments, the non-porous material comprises flexible polyethylene foam. The side portions 302, 304, 306, and 308 are attached together by seams that are impervious to vehicular fluids.

The bottom portion 324 is attached to the side portions 302, 304, 306, and 308 as indicated by arrow 316. In one embodiment, the side portions 302, 304, 306, and 308 are attached to the bottom portion 314 by a seam that is impervious to vehicular fluids. In one embodiment, the seams are formed with an ultrasonic seaming device. In another embodiment, the seams are formed with an impulse sealer.

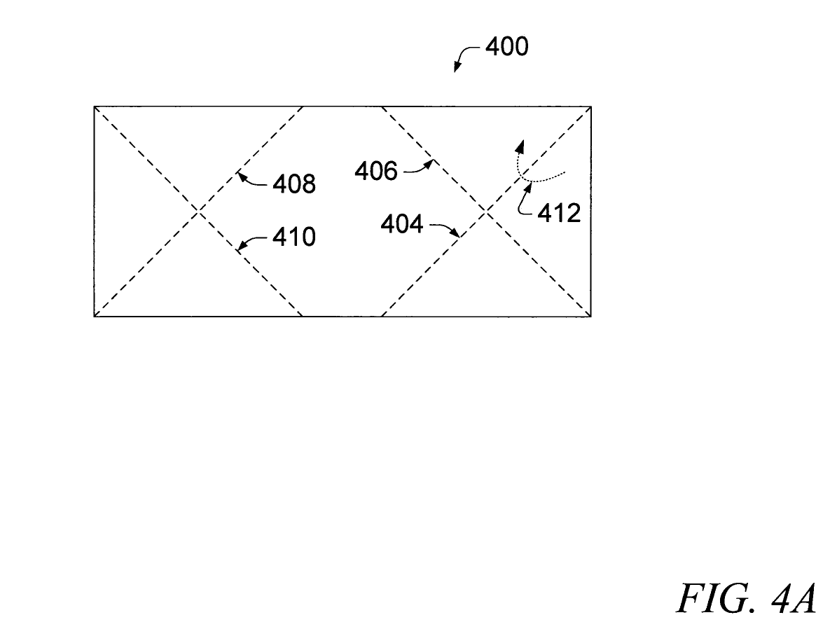

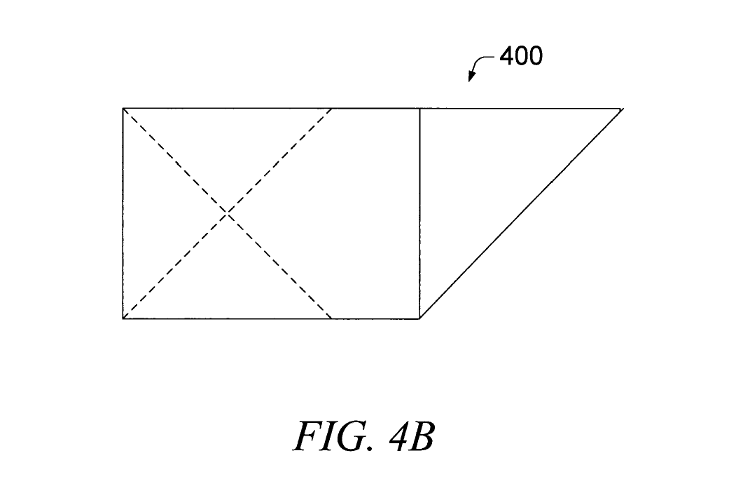

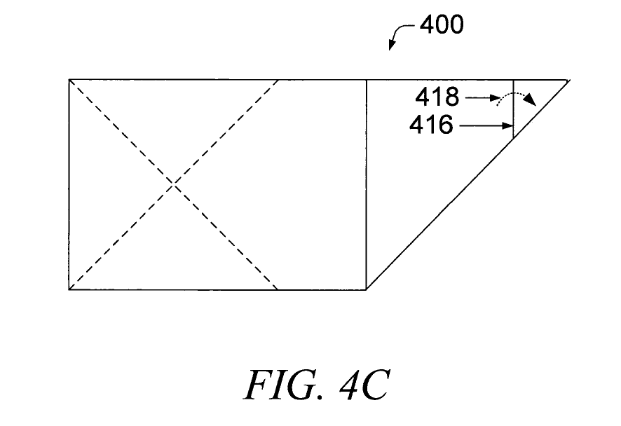

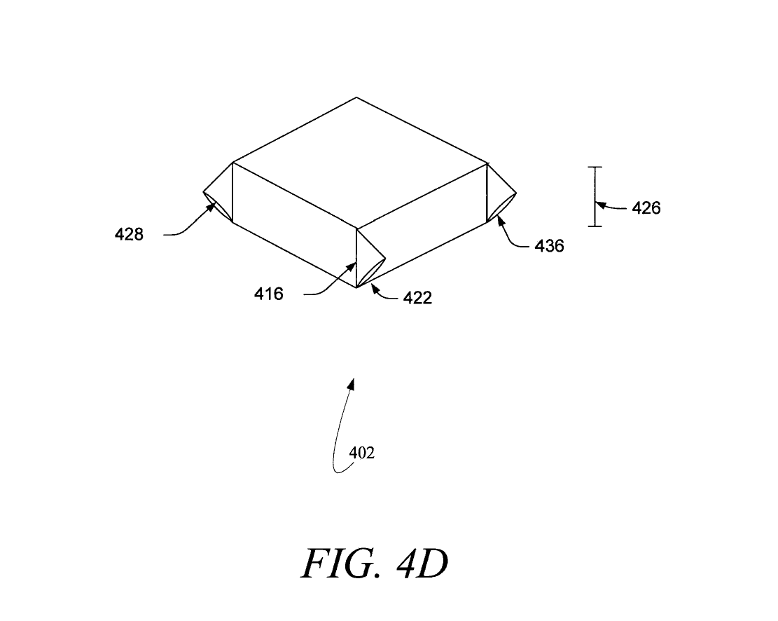

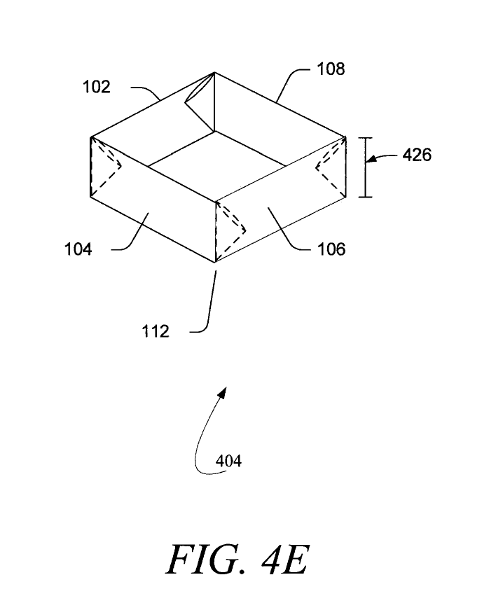

Referring to FIG. 4A, a continuous sheet of non-porous material 402 that is impervious to vehicular fluids is used to form side portions 102, 104, 106, 108, and bottom 114. The sheet of non-porous material 402 is shown with four dashed lines 404, 406, 408, and 410. The sheet of non-porous material 402 is folded along dashed line 404 as indicated by arrow 412.

FIG. 4B shows the configuration of subassembly 400 after making the first fold. Referring to FIG. 4C, a seam is created in subassembly 400 as shown by 416. In one embodiment, the seam is formed with an ultrasonic seaming device. In another embodiment, the seam is formed with an impulse sealer. The length of the seam determines the height of the side portions of the secondary containment system. Subassembly 400 is unfolded as shown by arrow 418.

FIG. 4D shows a subassembly 402 formed after four iterations (one for each corner) of the folding/unfolding of FIGS. 4B and 4C. The seam 416 creates a flap 422. The height 426 is equivalent to the length of the seam 416, and to the height of sides 102, 104, 106, and 108. This process of FIGS. 4B and 4C has been repeated for the three dashed lines 406, 408, 410 of FIG. 4A to form the remaining four corners of assembly 402, and generate flaps 428 and 436. In FIG. 4E, assembly 402 is turned “inside out” to give partial housing 404 comprising sides 102, 104, 106, 108, and bottom 112, wherein the four flaps created are now disposed within partial housing 404.

Referring to FIG. 5, flowchart 500 summarizes one embodiment for using the secondary containment system is shown. In step 505, the method provides a secondary containment system comprising a mattress, such as and without limitation Applicant's secondary containment system 100.

The source of the leak is identified in step 510. In one embodiment, the source may be from an external fuel tank or from other parts of a vehicle. In one embodiment, the vehicle may be any motorized vehicle that can house a mattress, such as a semi-truck or recreational vehicle (RV).

In step 520, the method deploys the secondary containment system of step 505. The secondary containment system is deployed under the source of the leak. The secondary containment system must be properly orientated, with the porous top section under and facing the leak. As the leaking liquid comes into contact with the top of the secondary containment system, the liquid penetrates the top of the secondary containment system, enters the core of the secondary containment system, and is contained by housing 105.

In step 530, the method determines if the flow of released vehicular fluids has stopped. If the flow of released vehicular fluids has stopped, the method pauses until the flow stops.

If the method determines in step 530 that the flow of released vehicular fluids has stopped, then the method transitions from step 530 to step 540 wherein the method determines whether to remove the captured vehicular fluids from housing 105. If the method elects not to remove the captured vehicular fluids from housing 105, then the method transitions from step 540 to step 545 wherein the method properly disposes of the secondary containment system containing the captured vehicular fluids.

Alternatively, if the method elects to remove the captured vehicular fluids from housing 105, then the method transitions from step 540 to step 550 wherein the method determines whether to use a recovery containment system and a hose having couplings on either end. If the method elects to use a recovery containment system and a hose having couplings on either end, then the method transitions from step 550 to step 560 wherein the method couples a recovery containment system to the secondary containment system containing the captured vehicular fluids. In certain embodiments, step 560 is performed by public safety personnel dispatched to the spill site, wherein those public safety personnel provide the recovery containment system. In certain embodiments, step 560 is performed by private sector personnel dispatched to the spill site, wherein those private sector personnel provide the recovery containment system.

In step 570, the method transfers the captured vehicular fluids from the secondary containment system to the recovery containment system. In certain embodiments, step 570 is performed by public safety personnel.

In step 580, the method properly disposes of the core portion of the now-emptied secondary containment system, wherein that core portion comprises residual vehicular fluids. In step 590, the method cleans the now empty housing 105, and disposes a new core portion into that cleaned housing. In step 595, the method disposes the refurbished secondary containment system into the vehicle of step 505.

If the method elects in step 550 not to use a recovery containment system and a hose having couplings on either end, then the method transitions from step 550 to step 552 wherein the method transports the secondary containment system containing captured vehicular fluids to a permitted waste facility. In step 554, the method transfers the captured vehicular fluids from housing 105. In certain embodiments, step 554 includes opening a valve, such as valve 114, to drain the captured vehicular fluids from housing 105. The method transitions from step 554 to step 580 and continues as described hereinabove.

Referring to FIG. 6, a flowchart 600 summarizes one embodiment for manufacturing Applicant's secondary containment system. A non-porous material, a mattress core, a material capable of absorbing vehicular fluids, a flame retardant and a drain are provided at step 602. The bottom and sides of the secondary containment system are attached to form the engine fluid retaining portion of the secondary containment system at 604. The surface and seams of the engine fluid retaining portion is non-porous and is impervious to vehicular fluids. In one embodiment, a drain is added to one of the sides.

The core of the mattress is formed at step 606. In one embodiment, the core comprises an innerspring. In another embodiment, the core comprises a polyurethane foam core. In one embodiment, the density of the polyurethane foam is 1.2-1.5 lbs per square inch. In yet another embodiment, the core also contains material capable of absorbing and retaining vehicular fluids, including petroleum based or synthetic liquids, such as diesel fuel, gasoline, engine lubricant, and transmission fluid. In another embodiment, the material capable of absorbing vehicular fluids may also be hydrophobic, allowing it to absorb and retain vehicular fluids without absorbing water, thereby maximizing the amount of vehicular fluids that can be captured. In yet another embodiment, the core includes baffles to compartmentalize the captured vehicular fluids. In yet another embodiment, the core includes, or is capable of receiving, a chemical compound that renders petroleum-based fuels non-flammable, such as PETRO-CLEAN. In yet another embodiment, the core includes a flame retardant.

A ticking is provided for the top surface of the mattress at step 608. The ticking may be any traditional mattress ticking material that can be configured to be porous to vehicular fluids. In one embodiment, the ticking is constructed of cotton, silk, or wool.

In certain embodiments, core 128 is disposed within a portion of housing 105, and then top portion 110 is disposed over the core and attached to the side portions 102, 104, 106, and 108, which along with the bottom portion 112, encase the core. Any means of attachment can be used. In one embodiment, the top portion 110 is fastened to the side portions 102, 104, 106, and 108 by stitching with thread.

The core is disposed into the volume formed by the engine fluid retaining portion of the secondary containment system at step 610. The ticking is disposed over the core at step 612. The ticking is attached to the engine fluid retaining portion of the secondary containment system at step 614. In one embodiment, the ticking is attached to the engine retaining portion of the secondary containment system by stitching with thread. The method ends at step 616.

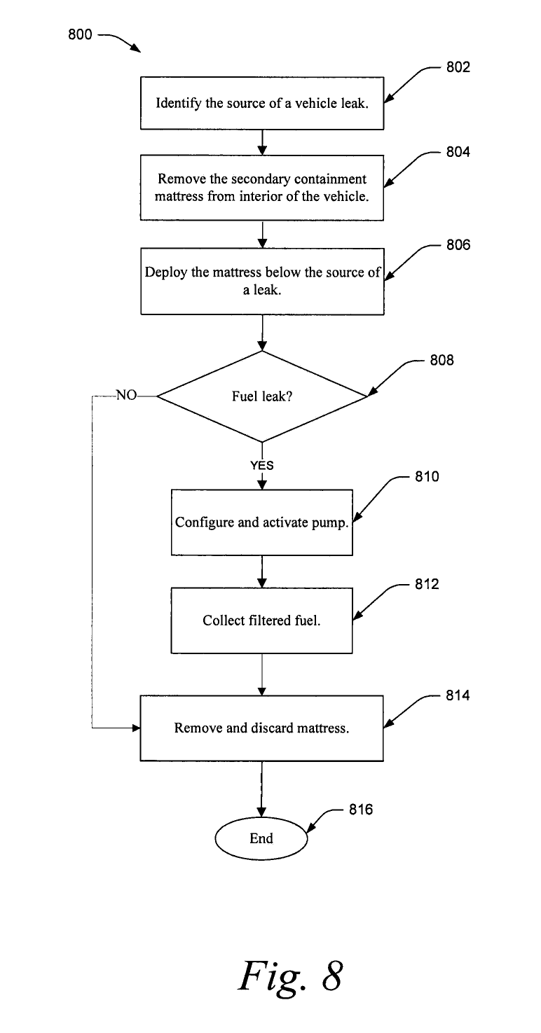

Referring to FIG. 8, a flowchart 800 summarizes another embodiment for using Applicant's secondary containment system. The source of the vehicle leak is detected at step 802. One embodiment of Applicant's secondary containment mattress system is removed from the interior of the vehicle at step 804. In one embodiment, the secondary containment mattress system is configured to be used as a bed for the driver of the vehicle. The secondary containment mattress system is deployed below the source of the leak at step 806. The secondary containment mattress system is deployed with the porous surface facing upwards toward the leak. As such, the leaking fluids fall onto the porous surface and penetrate through to the interior of the mattress. At step 808, the method determines if the leak is a fuel leak or a leak of another type of vehicular fluid, such as transmission fluid or oil. If the method determines at step 808 that the leak is a fuel leak, the method transitions to step 810.

A pump is operatively attached to the secondary containment mattress system to allow the pump to draw the captured liquid out from the interior of the secondary containment mattress system and activated at step 810. In different embodiments, the pump is connected to a valve on the secondary containment mattress system or inserted through a hole in the surface of the secondary containment mattress system. In one embodiment, in the case of a mattress with a foam core, the pump is configured to draw the liquid through a portion of the foam core, thereby filtering the liquid. In one embodiment, the pump draws the liquid through an external filter.

The filtered fuel is collected at step 812. In one embodiment, the filtered fuel is disposed into a separate fuel tank on the vehicle that is not leaking. In one embodiment, the filtered fuel is collected in canisters for later use. The method transitions to step 814.

If the method determines at step 808 that the leak is not a fuel leak, the method transitions to step 814.

Once a remediation crew arrives on the scene, secondary containment mattress system is removed and the mattress is discarded appropriately, and in accordance to governing laws at step 814. The method ends at step 816.

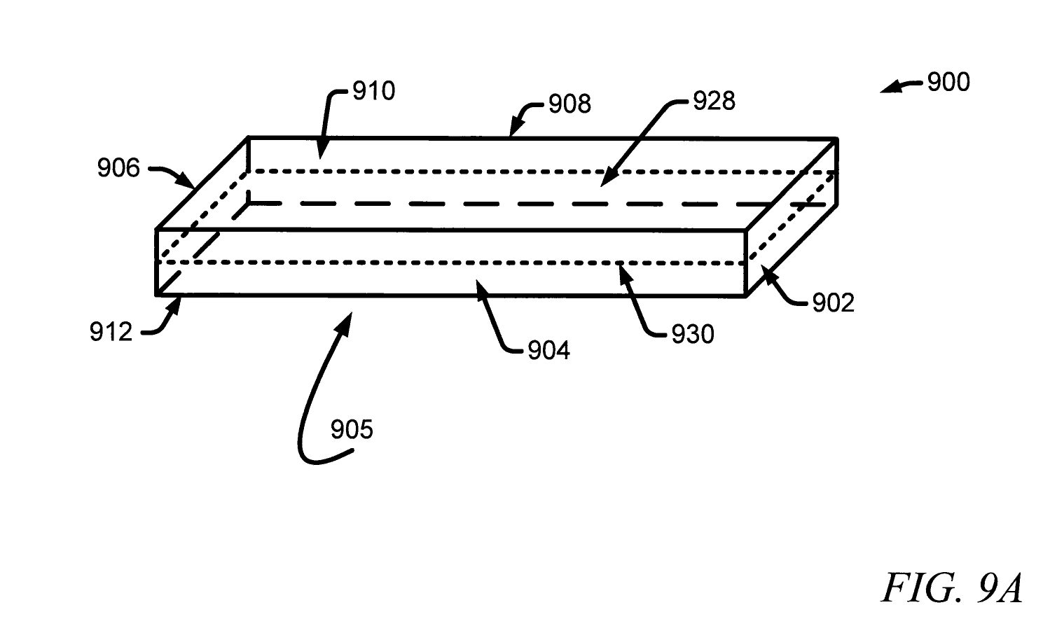

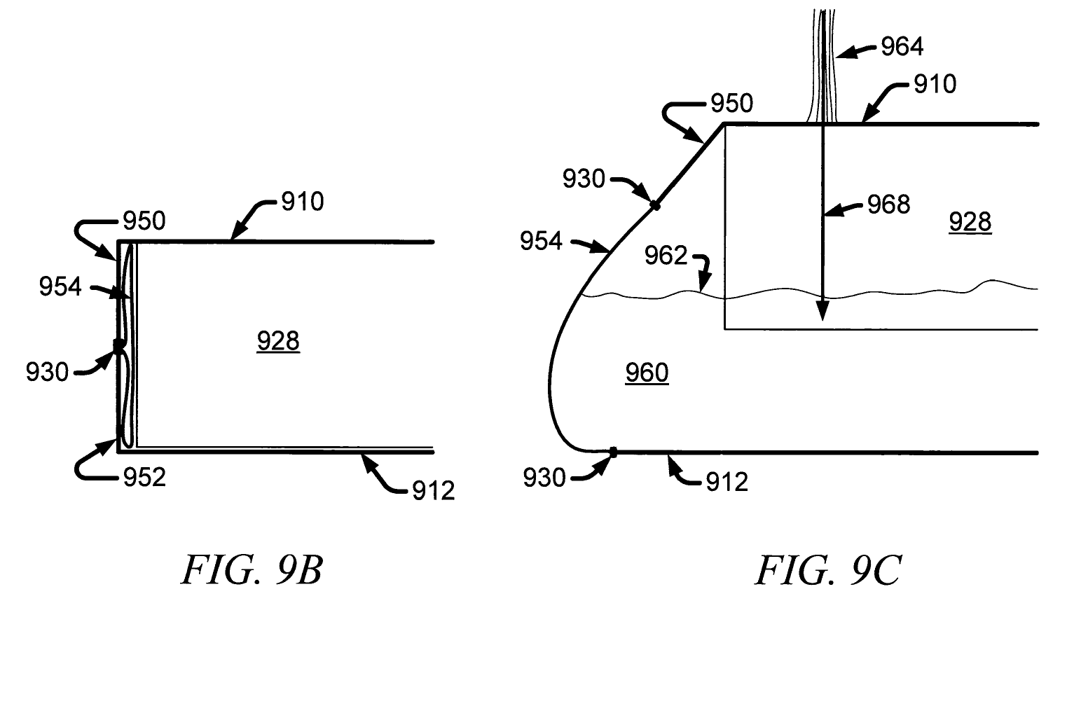

Referring to FIG. 9A, an expandable embodiment of Applicant's secondary containment system 900 is depicted. The secondary containment system 900 includes a porous top 910. The secondary containment system 900 also includes a non-porous housing 905. The housing 905 comprises sides 902, 904, 906, 908, and bottom 912. The housing 905 is constructed from a non-porous material that is impervious to vehicular fluids and configured to retain any contained vehicular fluids. The secondary containment system 900 also includes a core 928. In one embodiment, the core 928 is attached to the top 910 only (and not to the sides 902, 904, 906, 908, or the bottom 912). In one embodiment, the core is enclosed within the housing 905 and top 910, but not attached to any of the top 910, the sides 902, 904, 906, 908, or the bottom 912.

In another embodiment, the core 928 comprises a cellular material, i.e., a foam. In one embodiment, core 928 comprises polyurethane foam having about 1.2-1.5 lbs per square inch. In yet another embodiment, the core 928 further comprises one or more materials capable of absorbing and retaining vehicular fluids, including petroleum based or synthetic liquids, such as diesel fuel, gasoline, engine lubricant, and transmission fluid. In another embodiment, the material capable of absorbing vehicular fluids may also be hydrophobic, allowing it to absorb and retain vehicular fluids without absorbing water, thereby maximizing the amount of vehicular fluids that can be captured. In yet another embodiment, the core 928 includes baffles to compartmentalize the captured vehicular fluids. In yet another embodiment, the core 928 includes, or is capable of receiving, one or more chemical compounds that render petroleum-based fuels non-flammable, such as PETRO-CLEAN. In yet another embodiment, the core 928 includes one or more flame retardant materials that become dissolved in or dispersed in vehicular fluids when those vehicular fluids are directed onto, and into, the secondary containment system 900.

In one embodiment, a releasable attachment means 930 circumscribes the secondary containment system 900. Upon release, the sides 902, 904, 906, and 908 part along the seam and release additional material packed within the seam, which increases the exterior surface area of the secondary containment system 900 as well as the interior volume of the secondary containment system 900 available for retaining liquids. In one embodiment, the releasable attachment means 930 comprises a zipper with a slider. In such an embodiment, the releasable attachment means 930 is released by running the slider around the length of the releasable attachment means 930. In one embodiment, the releasable attachment means 930 comprises a permanent seam with a rip cord. The rip cord is pulled along the releasable attachment means 930 and, the permanent seam is ripped, opening the seam.

In one embodiment, a releasable attachment means 930 is disposed on only one side of the secondary containment system 900. When the attachment means 930 is released, the interior volume of the secondary containment system 900 is increased only on the side of the attachment means 930.

In one embodiment, a first portion of the releasable attachment means 930 is disposed on one side of the secondary containment system 900 and a second portion of the releasable attachment means 930 is disposed on the opposite side of the secondary containment system 900. When the first and second portions of the attachment means 930 are released, the interior volume of the secondary containment system 900 is increased due to the expansion of material on the two opposing sides, while the other two opposing sides do not expand.

In one embodiment, the releasable attachment means 930 is disposed on three sides of the secondary containment system 900. When the attachment means 930 is released, the interior volume of the secondary containment system 900 is increased due to the expansion of material on three sides, while the remaining side does not expand.

Referring to FIG. 9B, a cross section of a portion of the embodiment in FIG. 9A is depicted. Top segment 950 and bottom segment 952 make up the side of the secondary containment system 900. The two segments are releasably joined by attachment means 930. The top segment 950 is connected to the porous top 910. The bottom segment 952 is connected to the bottom 912.

The segments 950 and 952 are interconnected by segment 954. Segment 954 is packed between the core 928 and the segments 950 and 952. In one embodiment, the packed segment 954 is comprised of the same non-porous material as the sides 902, 904, 906, 908, and bottom 912.

In one embodiment, the core 928 is attached to the porous top 910 and is not attached to any of the sides 902, 904, 906, 908, or bottom 912. In one embodiment, the core 928 is not attached to any of the top 910, the sides 902, 904, 906, 908, or bottom 912.

FIG. 9C depicts the secondary containment system 900 retaining fluid 960 captured from stream 964. The releasable attachment means 930 has been separated into elements 930A and 930B, allowing the packed segment 954 to expand outward. The side of the secondary containment system 900, comprising of top segment 950, segment 954, and segment 952, has expanded to increase the interior volume of the secondary containment system 900. As fluid falls onto the secondary containment system 900, it penetrates the porous top 910 and the porous core 928 and collects in the bottom portion of the secondary containment system 900. As the liquid accumulates in the secondary containment system 900, it pushes the expanded sides (930, 954, and 930) outward. Also, in this embodiment, the core is comprised of foam with a relatively low density as compared to the captured vehicular fluids and, as such, the core 928 floats on the surface of 6\962 of the captured vehicular fluids 960. As additional captured vehicular fluids accumulate, the core 928 continues to rise. The internal volume of this embodiment enables the secondary containment system 900 to capture a significantly larger volume of vehicular fluids as compared to the non-expanding embodiment. In one embodiment, the secondary containment system 900, when expanded, is sized to capture the entire volume of the fuel tanks for the vehicle in which it resides. In one embodiment, the secondary containment system 900 is sized to capture between about 50 to about 200 gallons of fuel. In one embodiment, the secondary containment system 900 is sized to capture less then 50 gallons of fuel.

The secondary containment system 900 may also be deployed to contain a leak on a hill or other inclined surface because the core 928 will float on the surface 962 of the captured fuel 960. As the core 928 is lifted by the rising fuel 960, the upper portion of the top segment 950 is maintained above the fluid surface 962. As such, the floating core 928 provides a self-leveling mechanism for the secondary containment system 900, providing for enhanced liquid containment and recovery on a sloped or inclined surface.

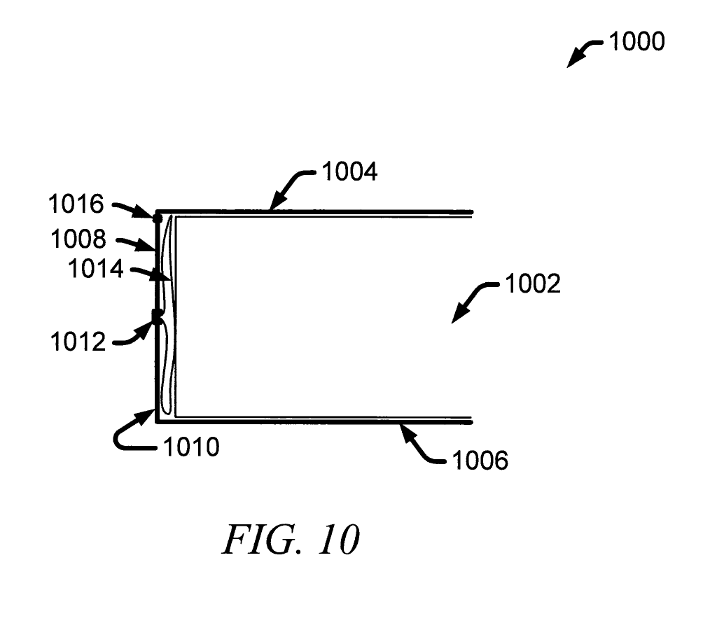

Referring to FIG. 10, a cross section of a portion of another expandable embodiment of Applicant's secondary containment system 1000 is depicted. A mattress 1002 is disposed within a flexible liner. The flexible liner comprises a porous top 1004, top segment 1008, bottom segment 1010, packed segment 1014, and bottom 1006. The sides (1008 and 1010), packed segment 1014, and bottom 1006 are constructed from a material that is impervious to vehicular fluids. In one embodiment, the mattress 1002 is a conventional mattress. In one embodiment, the mattress 1002 is a foam pad.

The two side segments 1008 and 1010 are releasably joined at attachment means 1012. The two segments are also connected by the packed segment 1014. In one embodiment, the packed segment 1014 is disposed between the segments (1008 and 1010) and the mattress 1002.

The bottom segment 1010 is connected to the bottom 1006. The top segment 1008 is releasably joined to the porous top 1004 by attachment means 1016. In one embodiment, the attachment means 1016 is positioned to allow the top 1004 to be removed and reattached to the top segment 1008. This configuration allows the flexible liner to be disposed around a conventional mattress and periodically replaced as necessary when, for example, the liner gets sufficiently dirty, drivers switch trucks, or a mattress is replaced.

When the secondary containment system 1000 is deployed to contain a leak, the attachment means 1012 may be separated, releasing the packed segment 1014 whereby the secondary containment system 1000 functions as described and illustrated herein with reference to FIG. 9C.

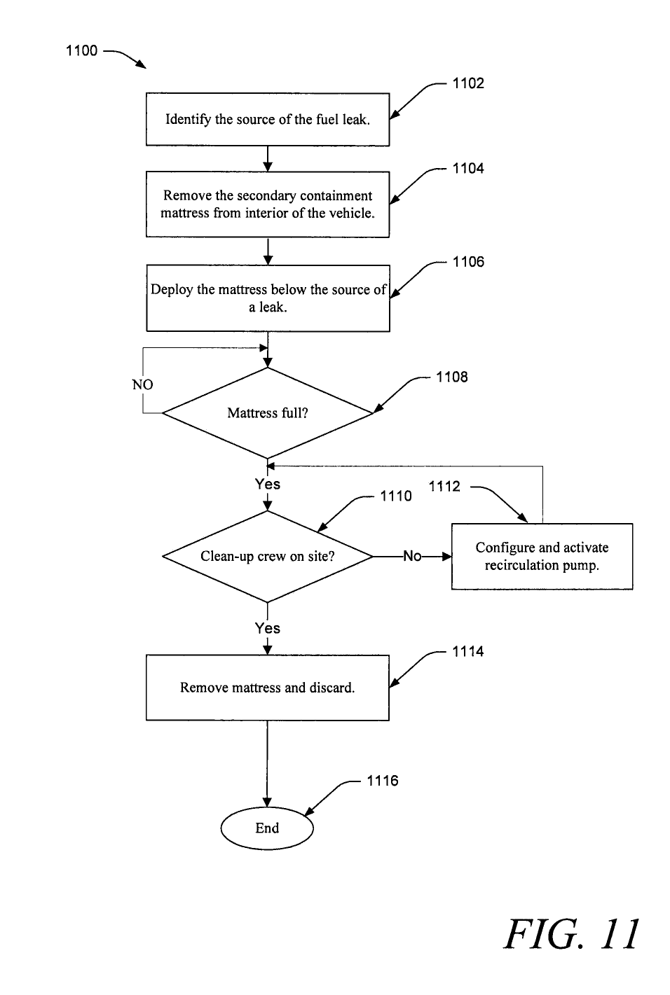

Referring to FIG. 11, flowchart 1100 summarizes one embodiment for using the secondary containment system to capture fuel from a vehicle fuel leak. The source of the leak is identified in 1102. In one embodiment, the source of the fuel may be from an external fuel tank or from other parts of the vehicle. In one embodiment, the vehicle may be any motorized vehicle that can house a mattress, such as a semi-truck or recreational vehicle (RV). In other embodiments, the vehicle may be any motorized vehicle that has seat cushions, such as a van, car, or pickup truck. In this embodiment, the mattress is configured to replace and function as a seat cushion, but all features and methods of construction and use (aside from shape) remain the same.

The secondary containment mattress system is removed from the interior of the vehicle at step 1104. The secondary containment mattress system is deployed under the source of the leak at 1106. The secondary containment mattress system must be properly orientated, with the porous top section under and facing the leak. As the leaking liquid comes into contact with the top of the secondary containment mattress system, the liquid penetrates the top of the secondary containment mattress system, enters the interior of the secondary containment mattress system, and is contained by the non-porous barrier along the bottom and sides of the secondary containment mattress system.

The secondary containment mattress system is evaluated at 1108 to determine if sufficient captured vehicular fluids have filled the secondary containment mattress system. If insufficient captured vehicular fluids have entered the secondary containment mattress system, the secondary containment mattress system is reevaluated at a future time at step 1108.

If sufficient captured vehicular fluids have entered the secondary containment mattress system 1108, the method determines whether a clean-up crew has arrived to remediate the spill and clean the area to render it safe for people, travelers, drivers, and the environment. If a clean-up crew has not arrived and the vehicular fluids continue to leak, an intermediate solution may be employed at 1112. The intermediate solution involves attaching a hose to the drain on the secondary containment mattress system. A pump is connected to the hose and the end of the hose opposite to the secondary containment mattress system is inserted into a fuel tank inlet. The pump is activated, pumping the captured fluids from the mattress into a fuel tank. This effectively increases the capacity of the secondary containment system. In one embodiment, where the secondary containment system can retain 60 gallons of leaking fuel and where the leaking fuel tank has a capacity of 110 gallons, the pumping mechanism, depending on the rate of leaking fuel, can effectively allow the secondary containment system to capture an amount over 60 gallons by recirculating the fuel back into the tank. The pumping continues until the clean up crew arrives at 1110.

If the clean up crew has arrived, the secondary containment system can be discarded at 1114. In one embodiment, the clean up crew can drain the secondary containment system using the drain. In another embodiment, the clean up crew can pump the captured engine fluid from the secondary containment system into a recovery and holding container. In yet another embodiment, the clean up crew can transport the entire secondary containment system still containing the captured engine fluid offsite for disposal. At which point the method ends at 1116.

The various steps or acts in a method may be performed in the order shown, or may be performed in another order. For example, in certain implementations, individual steps recited in FIGS. 5, 6, 8, and 11 may be combined, eliminated, or reordered.

Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods to implement the present invention.

It is understood that the examples and implementations described herein are for illustrative purposes only and that various modifications or changes in light thereof will be suggested to persons skilled in the art and are to be included within the spirit and purview of this application.

What is claimed is:

1. A secondary fuel containment system, comprising:
a housing comprising a parallelepiped impervious to vehicular fluids and formed to include an opening; and
a material porous to vehicular fluid disposed within said opening.

2. The secondary fuel containment system of claim 1, further comprising a mattress disposed within said housing.

3. The secondary fuel containment system of claim 1, wherein said material is releaseably attached to said housing.

4. The secondary fuel containment system of claim 2, wherein said material is integral with said mattress.

5. The secondary fuel containment system of claim 1, wherein:
said opening is defined by a first peripheral distance;
further comprising a means to alter said first peripheral distance of said opening to comprise a second peripheral distance;
wherein said second peripheral distance is less than said first peripheral distance.

6. The secondary fuel containment system of claim 1, wherein said housing is formed to include an aperture extending therethrough.

7. The secondary fuel containment system of claim 6, wherein said mattress is formed to include an internal channel, wherein:
said internal channel is in fluid communication with said aperture; and
said internal channel and aperture are configured to drain a liquid from an interior of said mattress.

8. The secondary fuel containment system of claim 2, wherein said mattress has a core type selected from said group consisting of innerspring and polyurethane.

9. The secondary fuel containment system of claim 2, wherein said mattress includes a compound capable of gelling petroleum-based fuel.

10. The secondary fuel containment system of claim 1, further comprising:
a first attachment means;
a second attachment means, wherein:
when said first attachment means is engaged with said second attachment means said housing comprises a first configuration comprising a first outer surface area;
when said first attachment means is disengaged from said second attachment means said housing comprises a second configuration comprising a second outer surface area; and
said second outer surface area is greater than said first outer surface area.

11. A secondary fuel containment system of claim 10, wherein:
said first attachment means comprises a first end and a second end, wherein said first end of said first attachment means is not disposed adjacent said second end of said first attachment means; and
said second attachment means comprises a first end and a second end, wherein said first end of said second attachment means is not disposed adjacent said second end of said second attachment means.

12. The secondary fuel containment system of claim 11, further comprising:
a third attachment means;
a fourth attachment means, wherein:
when said third attachment means is engaged with said fourth attachment means said housing comprises a third configuration comprising a third outer surface area;
when said third attachment means is disengaged from said fourth attachment means said housing comprises a fourth configuration comprising a fourth outer surface area; and
said fourth outer surface area is greater than said third outer surface area.

13. A secondary fuel containment system of claim 10, further comprising:
a foam mattress disposed within said housing, wherein:
said first attachment means comprises a loop extending around a middle portion of said housing; and
said second attachment means comprises a loop extending around a middle portion of said housing.

14. The secondary fuel containment system of claim 10, further comprising a mattress disposed within said housing, wherein said mattress:
is composed of a material with a density less than petroleum-based fuel; and
is configured to float on said vehicular fluids within said housing.

15. A method for capturing released vehicular fluids, comprising:
detecting a release of vehicular fluids from a vehicle;
providing a combination vehicle mattress and secondary fuel containment system, comprising a housing formed to include an opening, wherein:
said housing is impervious to vehicular fluids;
a mattress disposed within said housing; and
a porous surface disposed within said opening, wherein said porous surface is porous to vehicular fluids; and
disposing said combination vehicle mattress and secondary fuel containment system beneath said vehicle such that said released vehicular fluids are directed through said porous surface and into said mattress.

16. The method for capturing released vehicular fluids of claim 15, wherein providing a combination vehicle mattress and secondary fuel containment system includes removing said combination vehicle mattress and secondary fuel containment system from said interior of said vehicle.

17. The method for capturing released vehicular fluids of claim 15, further comprising, releasing an expandable portion of said housing to increase said interior volume of said combination vehicle mattress and secondary fuel containment system.

18. A method for making a combination vehicle mattress and secondary fuel containment system, comprising:
creating a housing impervious to vehicular fluids, wherein:
an opening is formed in said housing; and
said housing is sized to accommodate a mattress; and
disposing a mattress within said housing, wherein said housing is positioned to allow fluids passing through said opening to contact said mattress.

19. The method for making a combination vehicle mattress and secondary fuel containment system of claim 18, further comprising:
attaching a surface to said housing, wherein:
said surface spans said opening; and
said surface is porous to vehicular fluids.

20. The method for making a combination vehicle mattress and secondary fuel containment system of claim 18, further comprising, treating said mattress with a compound capable of gelling petroleum-based fuel.
